(19) United States
(12) Patent Application Publication
(10) Pub. No.: US 2007/0033101 A1
(43) Pub. Date: Feb. 8, 2007

(54) Source code allocation and match back system

(76) Inventor: Robert G. Gaito, Troy, NY (US)

Correspondence Address: Hoffman, Warnick & D'Alessandro LLC, 14th Floor, 75 State Street, Albany, NY, 12207, US

(21) Appl. No.: 11/265,608

(22) Filed: Nov. 2, 2005

Related U.S. Application Data
(60) Provisional application No. 60/706,462, filed on Aug. 8, 2005.

(51) Int. Cl. G06Q 30/00

(52) U.S. Cl. 705/14

(57) ABSTRACT

A source code allocation and match back system for processing unsourced orders. A system is described that includes: an identification system for identifying a candidate pool of promotions responsible for triggering an unsourced order, wherein the identification system utilizes an identifier associated with the unsourced order to search for a contact that participated in at least one promotion; and an order allocating system for allocating credit to at least one source code associated with the contact, wherein the order allocating system analyzes order curve data associated with the candidate pool of promotions to allocate credit.

### BACKGROUND OF THE INVENTION

This application claims the benefit of co-pending U.S. Provisional Application Ser. No. 60/706,462 filed on Aug. 8, 2005, and hereby incorporated herein by reference.

1. Technical Field

The present invention relates generally to a system and method for determining the effectiveness of marketing promotions, and more specifically relates to a source code allocation system and method for matching orders and allocating credit back to various marketing promotions.

2. Related Art

Due to today's highly competitive marketplace, large amounts of money must typically be spent by direct marketers on promotions to generate sales. This is particularly the case for catalog driven businesses in which the cost of producing and mailing catalogs is substantial. Accordingly, understanding which promotion or promotions resulted in sales allows the direct marketers to more effectively utilize their marketing resources for future marketing campaigns. One way to achieve this is to provide “source codes” on catalogs and ask the consumer for the source code when they are making a purchase. The business can then allocate credit to the source codes and associated catalog promotion and analyze the effectiveness of previous catalog campaigns. This process of crediting source codes with orders is generally referred to herein as source code allocation.

However, when consumers wish to place an order they can do so by utilizing any one of a variety of sales channels. They may place a phone order, purchase through the Internet, or if the marketer has a retail presence, the consumer may go directly to a store to complete the transaction. Such a vast array of choices makes it easy for the consumer to buy products, but at the same time makes it extremely difficult for the marketer to determine which promotional activity (if any) triggered the sale. Purchases that cannot be directly traced back to a promotional activity are categorized as “unsourced” purchases or orders.

Depending on the nature of the merchandise being sold, unsourced purchases for a direct market business can reach as high as 40% of the overall number of orders placed. Clearly these high percentages make it difficult for marketers to determine the effectiveness of their various marketing efforts. The problem is compounded by the fact that a given household may receive multiple copies of a catalog due to, e.g., duplicate names in a mailing list, different target purchasers residing in the same household, overlapping catalog campaigns, etc.

An important goal of nearly every source code allocation initiative is to “match back” unsourced orders to specific promotions to identify which promotions were believed to trigger a given purchase. Although this desire is not new to direct marketers, today's multi-channel marketplace has made it more challenging than ever. Because most catalogers typically have websites where consumers can place orders, and many consumers prefer web-based shopping, it is very difficult to determine what drove the consumer to the website.

Studies have shown the number of web-based orders correspond closely with catalog circulation. This means the catalog is often the vehicle that triggers a consumer to go to the website and place an order. Accordingly, a need exists for a system that can determine which promotions, as well as which source codes, are driving these unsourced sales.

### SUMMARY OF THE INVENTION

The present invention addresses the above-mentioned problems, as well as others, by providing a system and method that matches unsourced orders back to previous promotional campaigns and returns the source code (or source codes) most likely associated with the purchase.

In a first aspect, the invention provides a source code allocation system for processing unsourced orders, comprising: an identification system for identifying a candidate pool of promotions responsible for triggering an unsourced order, wherein the identification system utilizes an identifier associated with the unsourced order to search for a contact that participated in at least one promotion; and an order allocating system for allocating credit to at least one source code associated with the contact, wherein the order allocating system analyzes order curve data associated with the candidate pool of promotions to allocate credit.

In a second aspect, the invention provides computer program product stored on a computer usable medium for processing unsourced orders, comprising: program code configured for identifying a candidate pool of promotions responsible for triggering an unsourced order, wherein the program code configured for identifying a candidate pool of promotions utilizes an identifier associated with the unsourced order to search for a contact that participated in at least one promotion; and program code configured for allocating credit to at least one source code associated with the contact, wherein the program code configured for allocating credit analyzes order curve data associated with the candidate pool of promotions to allocate credit.

In a third aspect, the invention provides a method for processing unsourced orders, comprising: determining an identifier associated with an unsourced order, wherein the identifier uniquely identifies a contact associated with the unsourced order; searching for the identifier in a set of promotion history databases, wherein each promotion history database contains a list of contacts that participated in a unique promotion; identifying a candidate pool of promotions that were sent to the contact by determining which of the promotion history databases include the identifier; analyzing an order curve for each of the candidate pool of promotions; and allocating credit for unsourced order to at least one of the promotions based on the analysis.

In a fourth aspect, the invention provides method for deploying an application to process unsourced orders, comprising: providing a computer infrastructure being operable to: determine an identifier associated with an unsourced order, wherein the identifier uniquely identifies a contact associated with the unsourced order; search for the identifier in a set of promotion history databases, wherein each promotion history database contains a list of contacts that participated in a unique promotion; identify a candidate pool of promotions that were sent to the contact by determining which of the promotion history databases include the identifier; analyze an order curve for each of the candidate pool of promotions; and allocate credit for unsourced order to at least one of the promotions based on an analysis of the order curves.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a source code allocation system in accordance with the present invention.

FIG. 2 depicts incoming order, promotion history, and final candidate pool records in accordance with the present invention.

FIG. 3 depicts a set of order curves for the data in FIG. 2.

FIG. 4 depicts a table of the data associated with the curves of FIG. 3.

FIG. 5 depicts an allocated order in accordance with the present invention.

FIG. 6 depicts a channel report in accordance with the present invention.

FIG. 7 depicts an alternative channel report in accordance with the present invention.

### DETAILED DESCRIPTION OF THE INVENTION

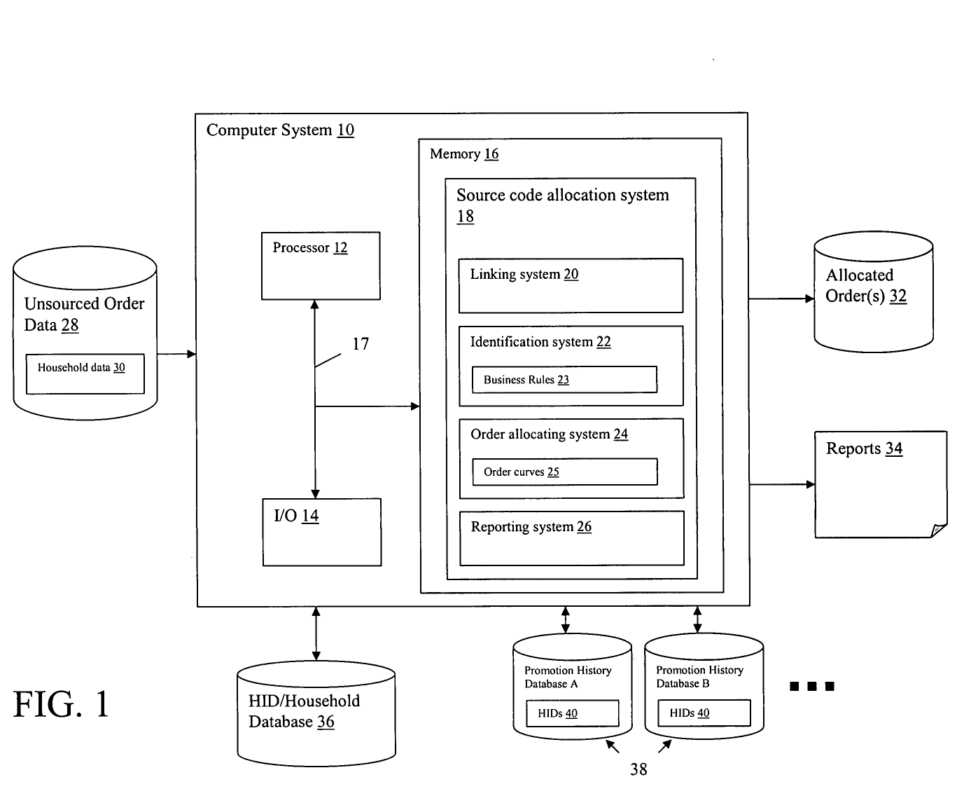

Referring now to drawings, FIG. 1 depicts a computer system 10 having a source code allocation system 18 that provides source code allocation and match back processing for inputted unsourced order data 28. More particularly, source code allocation system 18 examines unsourced order data 28, matches each unsourced order back to one or more promotions (e.g., catalog mailings, marketing campaigns, etc.), and allocates credit for each unsourced order to the one or more matched promotions. The resulting allocated order(s) 32 can then be outputted alone or as part of one or more reports 34.

As noted above, unsourced order data 28 generally comprises orders (e.g., purchases) taken by a business without a source code that directly links the order to a marketing promotion. In the illustrative embodiments described herein, in addition to including price and product data, unsourced order data 28 includes household data 30 associated with each order, which would be typical for orders taken over the phone or via the Internet. Household data 30 may for instance include the purchaser's name, address, email address, etc. Utilizing the household data 30, source code allocation system 18 can match an unsourced order with one or more promotions previously presented to the purchaser, and then allocate credit for the unsourced order to the one or more matched promotions.

Source code allocation system 18 comprises various subsystems that include: a linking system 20 for associating orders with household identifiers (HIDs); an identification system 22 for identifying a candidate pool of promotions; an order allocating system 24 for allocating credit for an order to one or more promotions; and a reporting system 26 for generating reports 34.

In this illustrative embodiment, an HID/Household database 36 is provided that stores a list of households and a unique and persistent household identifier (HID) to identify each unique household in the database. A system for implementing such a database is described in detail in U.S. patent application Ser. No. 10/091,956, Publication Number US/2003-0171942 A1, entitled “Contact Relationship Management System and Method,” filed on Mar. 6, 2002, which is hereby incorporated in its entirety by reference. In the aforementioned publication, a front end system is provided that receives, cleanses, and merges lists of contacts (e.g., mailing lists) and assigns a unique identifier to each unique contact that does not already have such an identifier. The resulting list is stored in a contact database, which in the case of the present invention essentially comprises the HID/Household database 36. The use of identifiers to process contact and order information greatly reduces the computational resources required for back-end processes, such as those performed by source code allocations system 18. As noted, in the illustrative embodiments described herein, household identifiers (HIDs) are utilized to identify unique households. However, it should be understood that the invention is not limited to using HIDs. Rather, other types of contact identifiers could instead be utilized, e.g., personal identifiers that distinguish among unique people, business identifiers that distinguish among businesses, a geographic identifier that identifies a specific geography, etc.

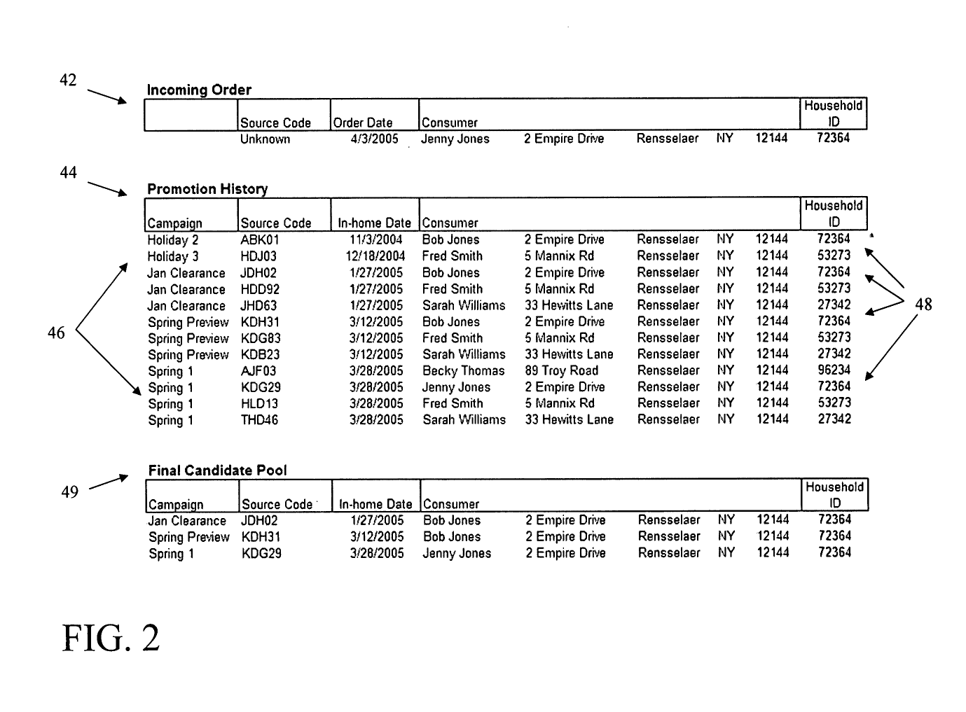

When processing an unsourced order, linking system 20 first cross-references the household data 30 contained in the unsourced order with the HID/Household database 36 to determine the HID for the unsourced order. Note that if the household that placed the order could not be found in HID/Household database 36, then that would indicate that the household did not receive any promotions, as the household was not in the database of contacts used for the promotions. Assuming the household was located in the HID/Household database 36, the associated HID would be linked to the unsourced order. FIG. 2 depicts an example of an incoming unsourced order 42 to which a HID has been linked. In this example, the HID is 72364 .

Once the HID for the unsourced order is determined, identification system 22 identifies a candidate pool of promotions from promotion history databases 38. In the embodiment shown in FIG. 1, each promotion history database (A, B . . . ) 38 comprises a list of contacts for a unique promotion (e.g., catalog mailing). For instance, database A may comprise a mailing list for a late autumn mailing, while catalog B comprises a mailing list for a Christmas mailing, etc. Each contact listed in each database 38 includes an associated HID 40. (US Publication Number US/2003-0171942, discussed above, likewise discloses a process for implementing promotion history databases 38.) Thus, once the HID is known for an unsourced order, identification system 22 can quickly sort though each of the databases 38 to find any matching HIDs, which can then be used to form a pool of candidate promotions that may have triggered the order. Anytime a matching HID was located in one the promotional history databases 38, it would indicate that the household received the promotion associated with the database.

Referring again to FIG. 2, a simplified promotion history 44 is shown that includes data for a plurality of promotions, i.e., campaigns 46. (In this example, each of the campaigns is concatenated into a single file, as opposed to residing in separate databases.) In this case, the household ID 72364 of the incoming order 42 can be easily searched in the promotion history 44 to generate a final candidate pool 49 of promotions. Note that the household ID 72364 appears in four different campaigns 48, including Holiday 2, Jan Clearance, Spring Preview, and Spring 1. Also note that because the promotion history is household-based, different members of the household (Bob and Jenny) received promotions. The final candidate pool 49 of promotions for this order could include all offers sent to the Jones household at the 2 Empire Drive address in November, January, February, and March of 2005. However, in this case, the promotion sent to the Jones household on Nov. 3, 2004 is not selected as part of the final candidate pool 49. Instead, a set of customizable business rules 23 (FIG. 1) are utilized to filter out promotions that occurred more than 90 days prior to the date the order was placed. It is understood that the business rules 23 can be implemented and customized in any manner to meet the needs of the particular client, e.g., they can be set up to select and filter results based on dates, order amounts, campaigns, order type, etc.

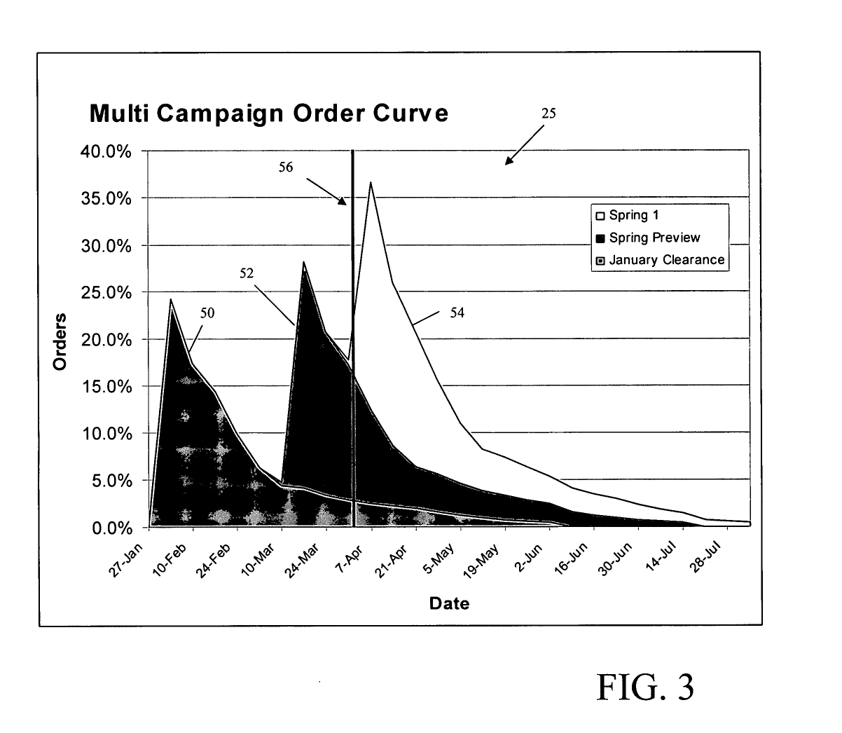

Once a final candidate pool 49 of promotions have been obtained for a specific order, order allocating system 24 is utilized to determine which promotion, or set of promotions, most likely triggered the order. In making this determination, a set of order curves 25 (FIG. 1) associated with each campaign are analyzed. FIG. 3 depicts an example of three order curves for the January Clearance, Spring Preview and Spring 1 campaigns used in the above example. As can be seen, curves associated with older campaigns overlap curves associated with newer campaigns. The area under each of the curves 25 depicts a percentage of orders attributable to the campaign over time. As can be seen, the highest percentage of orders come shortly after the mailing, and then tend to tail off over time. Order curves 25, such as those shown in FIG. 3 are regularly used an understood in the art.

In the example above, the incoming order 42 was received on Apr. 3^{rd} 2005, which is shown by the vertical bar 56 in FIG. 3. Thus, by analyzing the curves 25, it is known that the January Clearance mailing 50 is winding down and the Spring 1 mailing 54 has not yet ramped up, so it is reasonable to assume that the order was most likely triggered by the Spring Preview campaign 52, which is in full swing. However, based on the fact that each curve overlaps with the vertical bar 56, it is conceivable that any of the three campaigns from the final candidate pool 49 could have triggered the order. However, note that the length of overlap of the vertical line 56 and the individual order curves 50, 52, 54 is most significant with the Spring Preview campaign 52. Accordingly, one interpretation would suggest that the Spring Preview campaign 52 most likely triggered the order. Different approaches for interpreting the curve data are discussed below with reference to order allocating system 24.

Order allocating system 24 can either allocate the credit for an order to a single promotion or to multiple promotions. Assuming the business would like to allocate credit to a single order, two illustrative methods are described. The first method utilizes order curve information to determine which promotion “most likely” triggered the purchase, as discussed above. Using this technique, the campaign responsible for driving the largest amount of orders on the date the purchase in question was made receives credit for the purchase. Using the example above involving an April 3^{rd} order from Bob Jones, the order curve table depicted in FIG. 3 would be analyzed and order allocating system 24 would credit the order to the source code of KDH31 from the Spring Preview Campaign as being “most likely” to have caused the purchase since the corresponding curve 52 contained the greatest length of overlap of the vertical line 56.

The second method is driven purely by timeliness. The most recent promotion prior to the actual order date is credited with the order and the source code associated with that promotion is posted on the purchase record. In this case, order allocating system 24 would credit the order to the source code of KDG29 for the Spring 1 Campaign 54, since it was the most recent mailing prior to the order.

In a more refined embodiment, order allocating system 24 can be directed to allocate percentages of credit for an order to multiple campaigns. Because a consumer often receives multiple promotions prior to making a purchase, it can be said that each promotion played a role in triggering the purchase and that credit for the order should not be attributed back to a single source code. In this embodiment, the order curves 25 associated with each relevant promotion are analyzed to calculate a relative likelihood each promotion played in influencing the purchase. From this information, a corresponding percentage of the purchase can be allocated to each relevant promotion, and more specifically to each source code.

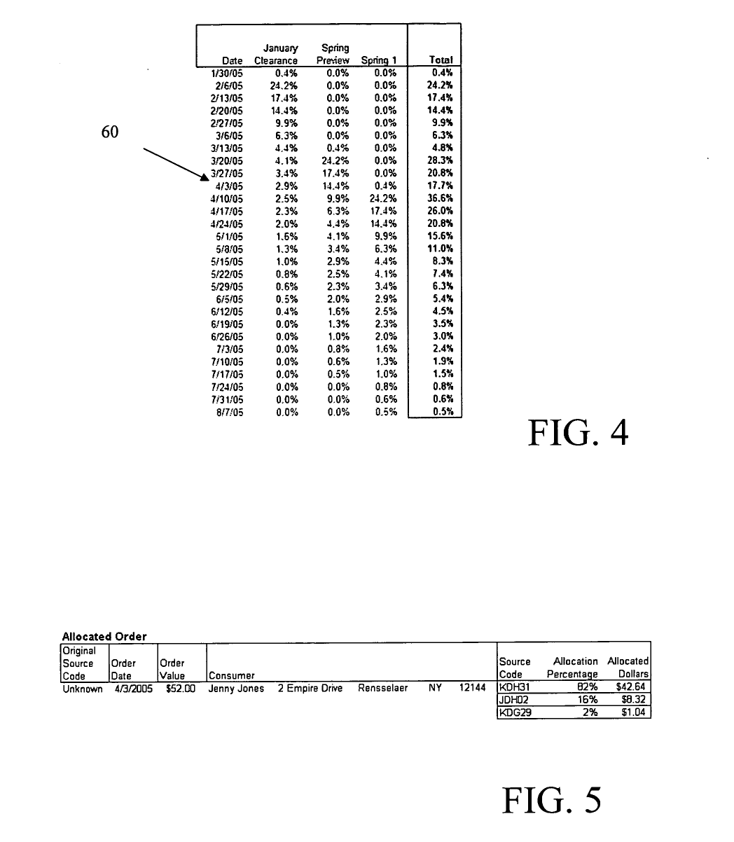

FIG. 4 depicts an order curve table associated with the curves 25 shown in FIG. 3. By analyzing the associated order curve table, the anticipated sales for April 3^{rd}, the date of the sample order 60, can be assessed. The table shows the January Clearance book is receiving 2.9% of its overall orders, the Spring Preview book is receiving 14.4% of its overall orders and the Spring 1 book is receiving 0.4% of its overall orders.

Presenting these statistics in relative terms, the January Clearance order curve represents 16% of the overall order curve for April 3^{rd} (2.9/17.7=0.16), the Spring Preview curve represents 82% of the overall order curve for April 3^{rd} (14.4/17.7=0.82) and the Spring 1 curve represents 2% of the overall order curve for this date (0.4/17.7=0.02). Thus, credit for the incoming order 42 can be allocated 16:82:2 to the January Clearance, Spring Preview, and Spring 1 campaigns, respectively. FIG. 5 depicts the allocated order 32, broken down by source code, percentage and dollar amount.

Thus, the order allocating system 24 allocates a portion of credit for the unsourced order to each of the promotions in the final candidate pool 49 of promotions based on a relative percentage of orders associated with each order curve for the order date of the unsourced order. The order allocating system 24 also identifies a source code from each promotion in the final candidate pool 49 of promotions for the contact associated with the unsourced order, allocates a percentage of credit for each identified source code, and allocates a dollar amount for each source code.

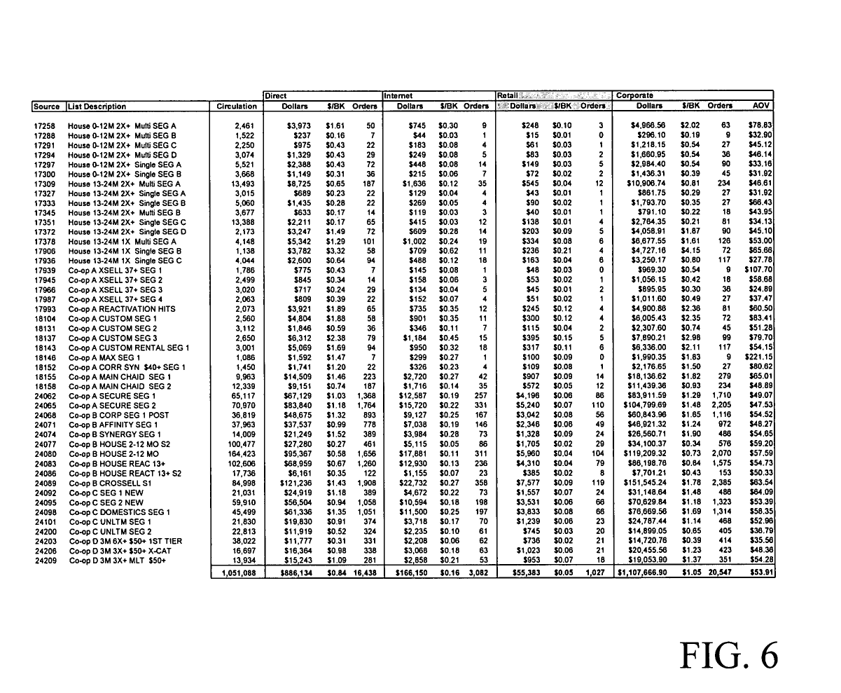

Finally, source code allocation system 18 includes a reporting system 26 for generating reports 34. FIG. 6 depicts a channel report for a catalog campaign that shows the relationships for direct sales, internet sales, retails sales and corporate sales, as a function of circulation for a given demographic. In today's multi-channel environment it is imperative to understand the relationship between direct marketing efforts and the channels in which purchases are made. For example, without knowing the impact catalog mailings have on internet sales, a business will not be able to fully measure the success of a catalog campaign. Similarly, it is also important to understand the degree to which email campaigns and direct mail campaigns affect retail sales.

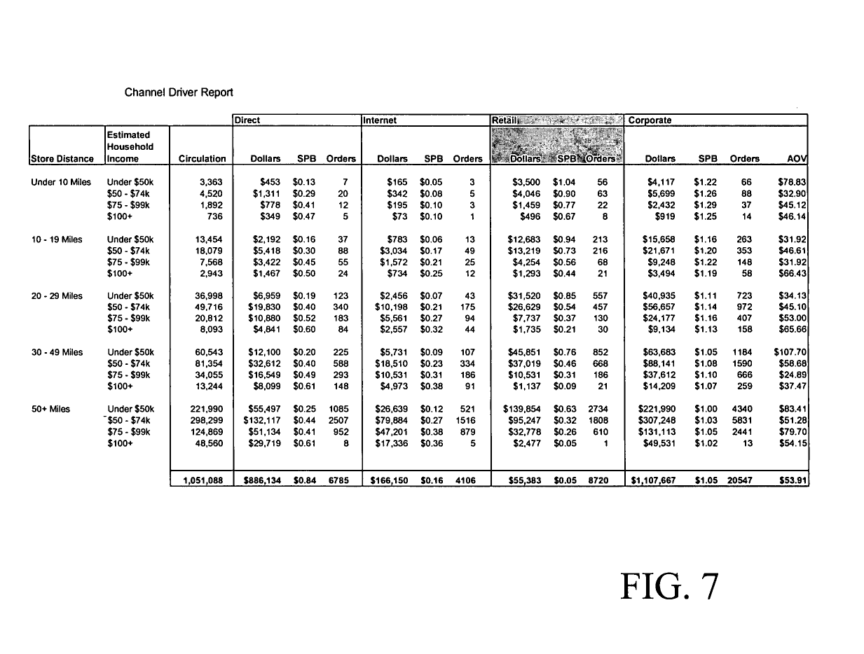

FIG. 7 depicts an alternative report for a catalog campaign that shows the relationships for direct sales, internet sales, retails sales and corporate sales, as a function of store distance and household income. This report is useful to understand how other non-promotion related characteristics drive each channel. For example, this shows how direct mail campaigns affect retail sales for consumers that live within 10, 20, 30, and 50 miles from the nearest store and whether there are any correlations between channel sales and demographic variables such as age, income, and education level.

The sample report shows the impact that store distance and household income have on each channel. It can be seen that the closer the consumer is to a store, the better the consumer performs across all channels. This phenomenon is most likely a result of brand awareness. The report also shows that consumers that have a household income between $50 k and $75 k are most likely to make a retail purchase. Obviously, the information gathered by using the allocation processes described above could be incorporated into any type of report, and the reports shown in FIGS. 6 and 7 are for illustrative purposes only.

In general, as depicted in FIG. 1, source code allocation system 18 could be incorporated within any type of computer system 10, e.g., a desktop, a laptop, a workstation, handheld device, etc. Moreover, computer system 10 could be implemented as part of a client and/or a server. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising source code allocation system 18 could be created, maintained and/or deployed by a service provider that offers the functions described herein for customers. That is, a service provider could offer to match back and/or allocate credit for orders as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A source code allocation system for processing unsourced orders, comprising:
an identification system for identifying a candidate pool of promotions responsible for triggering an unsourced order, wherein the identification system utilizes an identifier associated with the unsourced order to search for a contact that participated in at least one promotion; and
an order allocating system for allocating credit to at least one source code associated with the contact, wherein the order allocating system analyzes order curve data associated with the candidate pool of promotions to allocate credit.

2. The source code allocation system of claim 1, wherein the identifier is selected from the group consisting of: a household identifier and a personal identifier.

3. The source code allocation system of claim 1, wherein the identifier associated with the unsourced order is determined by a linking system that searches an identifier database for contact data that matches contact data in the unsourced order.

4. The source code allocation system of claim 1, further comprising a plurality of promotion history databases, each containing contact data and identifiers for a set of contacts that participated in a unique promotion.

5. The source code allocation system of claim 1, wherein the identification system includes a set of customizable business rules for selecting and filtering promotions from the candidate pool of promotions.

6. The source code allocation system of claim 1, wherein the order allocating system allocates credit for the unsourced order to the promotion that has an order curve with a highest percentage of orders on an order date of the unsourced order.

7. The source code allocation system of claim 1, wherein the order allocating system allocates a portion of credit for the unsourced order to each of the promotions in the candidate pool of promotions based on a relative percentage of orders associated with each order curve on an order date of the unsourced order.

8. The source code allocation system of claim 7, wherein the order allocating system identifies the source code from each promotion in the candidate pool of promotions for the contact, allocates a percentage of credit for each identified source code, and allocates a dollar amount for each source code.

9. A computer program product stored on a computer usable medium for processing unsourced orders, comprising:
program code configured for identifying a candidate pool of promotions responsible for triggering an unsourced order, wherein the program code configured for identifying a candidate pool of promotions utilizes an identifier associated with the unsourced order to search for a contact that participated in at least one promotion; and
program code configured for allocating credit to at least one source code associated with the contact, wherein the program code configured for allocating credit analyzes order curve data associated with the candidate pool of promotions to allocate credit.

10. The computer program product of claim 9, wherein the identifier is selected from the group consisting of: a household identifier and a personal identifier.

11. The computer program product of claim 9, wherein the identifier associated with the unsourced order is determined by searching an identifier database for contact data that matches contact data in the unsourced order.

12. The computer program product of claim 9, further comprising program code configured for accessing a plurality of promotion history databases, each containing contact data and identifiers for a set of contacts that participated in a unique promotion.

13. The computer program product of claim 9, further comprising program code configured for interpreting a set of customizable business rules for selecting and filtering promotions from the candidate pool of promotions.

14. The computer program product of claim 9, wherein credit for the unsourced order is allocated to the promotion that has an order curve with a highest percentage of orders on an order date of the unsourced order.

15. The computer program product of claim 9, wherein a portion of credit for the unsourced order is allocated to each of the promotions in the candidate pool of promotions based on a relative percentage of orders associated with each order curve on an order date of the unsourced order.

16. The computer program product of claim 15, wherein the source code from each promotion in the candidate pool of promotions is identified for the contact, a percentage of credit is allocated to each identified source code, and a dollar amount is allocated to each identified source code.

17. A method for processing unsourced orders, comprising:
determining an identifier associated with an unsourced order, wherein the identifier uniquely identifies a contact associated with the unsourced order;
searching for the identifier in a set of promotion history databases, wherein each promotion history database contains a list of contacts that participated in a unique promotion;
identifying a candidate pool of promotions that were sent to the contact by determining which of the promotion history databases include the identifier;
analyzing an order curve for each of the candidate pool of promotions; and
allocating credit for unsourced order to at least one of the promotions based on the analysis.

18. The method of claim 17, wherein the identifier is selected from the group consisting of: a household identifier and a personal identifier.

19. The method of claim 17, wherein the identifier associated with the unsourced order is determined by searching an identifier database for contact data that matches contact data in the unsourced order.

20. The method of claim 17, wherein the identifying step includes the step of interpreting a set of customizable business rules to select and filter promotions from the candidate pool of promotions.

21. The method of claim 17, wherein credit for the unsourced order is allocated to the promotion that has an order curve with a highest percentage of orders on an order date of the unsourced order.

22. The method of claim 17, wherein a portion of credit for the unsourced order is allocated to each of the promotions in the candidate pool of promotions based on a relative percentage of orders associated with each order curve on an order date of the unsourced order.

23. The method of claim 22, comprising the further steps of:
identifying the source code from each promotion in the candidate pool of promotions for the contact associated with the unsourced order;
allocating a percentage of credit to each identified source code; and
allocating a dollar amount to each identified source code.

24. A method for deploying an application to process unsourced orders, comprising:
providing a computer infrastructure being operable to:
determine an identifier associated with an unsourced order, wherein the identifier uniquely identifies a contact associated with the unsourced order;
search for the identifier in a set of promotion history databases, wherein each promotion history database contains a list of contacts that participated in a unique promotion;
identify a candidate pool of promotions that were sent to the contact by determining which of the promotion history databases include the identifier;
analyze an order curve for each of the candidate pool of promotions; and
allocate credit for unsourced order to at least one of the promotions based on an analysis of the order curves.
